(19) United States
(12) Patent Application Publication
(10) Pub. No.: US 2020/0206857 A1
(43) Pub. Date: Jul. 2, 2020

(54) Metal cutting machine with anti-cutting hands

(71) Applicant: Suyang Yu, Fuzhou City (CN)

(72) Inventor: Suyang Yu, Fuzhou City (CN)

(21) Appl. No.: 16/812,310

(22) Filed: Mar. 8, 2020

(30) Foreign Application Priority Data
Nov. 12, 2019 (CN) 2019111031487

(51) Int. Cl. B23Q 11/00; B23Q 17/24

(52) U.S. Cl. CPC B23Q 11/0092; B23Q 2717/00; B23Q 17/2438

(57) ABSTRACT

The invention discloses a metal cutting machine with anti-cutting hands, which includes a cutting base. The cutting base is provided with a main power cavity, and the main power cavity is provided with a power device. The power device can provide a device for the device. Power. The invention has a simple structure, convenient maintenance, and easy use. The device can automatically adjust the cutting position, and at the same time, it can automatically monitor the living body during the metal cutting process. When the human body enters the danger zone, it can automatically start the built-in The emergency clamping device clamps the blade, so that the blade stops rotating, preventing the blade from cutting the human body and causing injury to the human body, thereby greatly improving the safety during production and preventing accidental injury.

### CROSS-REFERENCES TO RELATED APPLICATIONS

The present application claims priority from Chinese application No. 2019111293954 filed on Sep. 19, 2019 which is hereby incorporated by reference in its entirety.

### TECHNICAL FIELD

The invention relates to the field of metal cutting, in particular to a metal cutting machine with anti-cutting hands.

### BACKGROUND OF THE INVENTION

Metal materials are widely used in people's lives because of their properties such as gloss, ductility, easy conductivity, and heat transfer. Among them, steel is the most widely used material, called “industrial skeleton”. Therefore, due to different needs, Metal materials need to be cut, and most common metal cutting machines are not equipped with automatic protection devices. In actual production, workers can easily cut themselves and be injured if they are slightly careless in operation. Therefore, existing The metal cutting device is optimized so that it will not harm the operator during the production process.

### BRIEF SUMMARY OF THE INVENTION

Technical problem: Most common metal cutting machines are not equipped with automatic protection devices. In actual production, workers can easily cut themselves and be injured if they are inadvertently operated.

In order to solve the above problems, this example designs a metal cutting machine with an anti-cutting hand. A metal cutting machine with an anti-cutting hand in this example includes a cutting base. The cutting base is provided with a main power cavity. A power device is provided in the main power chamber, and the power device can provide power for the device. A pulley chamber is provided in the upper wall of the main power chamber, a slide device is provided in the pulley chamber, and a slide device is provided in the slide device. A rotatable sliding gear, a lower side of the sliding gear is provided with a sliding box that can slide left and right, and a rack is fixed at the upper end of the sliding box, so that the lower end of the sliding gear can be meshed with the sliding box. There is a cutting box that can slide up and down. The cutting box is equipped with a cutting device that can cut metal materials. The sliding device is equipped with a rotatable lower transmission gear and the power device. A rotatable upper drive shaft is provided therein, the upper end of the upper drive shaft extends into the pulley cavity, and the upper end of the upper drive shaft is fixedly connected to the lower drive gear, so that the power device can pass through the upper drive Shaft and The lower transmission gear transmits power to the sliding device, and the sliding device can drive the sliding box to slide left and right. A gear cavity is provided in the lower wall of the main power cavity, and a cutter lifting device is provided in the gear cavity. The cutter lifting device is provided with a rack that can slide up and down, a left end of the rack is fixedly provided with a connecting rod, and the left end of the connecting rod is fixedly connected with the cutting box, so that the cutter lifting device can pass through the connecting rod drives the cutting box to slide up and down. The cutter lifting device is provided with a rotatable first bevel gear. The power device is provided with a rotatable lower transmission shaft. The lower end of the lower transmission shaft and the first A bevel gear is fixedly connected, so that the power device can transmit power to the cutter lifting device.

Wherein, the power device includes a main motor fixedly installed in the pulley cavity, a first power shaft is dynamically connected to the main motor, and a hollow shaft is sleeved symmetrically on the upper and lower ends of the first power shaft. The hollow shaft and the first power shaft are connected by a spline, a magnetic block is fixed at the right end of the hollow shaft, and a first electromagnet is fixed on the upper transmission shaft. When the first electromagnet is energized, Can attract the magnetic block at the upper end, the hollow shaft at the upper end can be meshed with the upper drive shaft, the hollow shaft at the lower end can be meshed with the lower drive shaft, and the lower drive shaft A second electromagnet is fixed on the upper part, and when the second electromagnet is energized, the magnetic block at the lower end can be attracted.

Wherein, the sliding device includes a driving shaft rotatably provided in the pulley cavity, and an upper transmission gear is fixed on the driving shaft, and the lower end of the upper transmission gear is meshed with the lower transmission gear. The lower end of the lower transmission gear is fixedly connected to the upper transmission shaft. A driving wheel is provided on the driving shaft. The driving wheel is located at the front end of the upper driving gear. A belt is connected to the driving wheel. The left end of the driving shaft is connected. The array is provided with five pulley shafts. Belt pulleys are fixed on the pulley shafts. The belt pulleys and the driving wheels are connected through the belts. The sliding gears are fixed on the pulley shafts.

Wherein, the cutter lifting device includes a positioning shaft rotatable in the gear cavity, a second bevel gear is fixed on the positioning shaft, and an upper end of the second bevel gear is engaged with the first bevel gear. The upper end of the first bevel gear is fixedly connected to the lower transmission shaft. A lifting gear is fixed on the positioning shaft. The lifting gear is located at the rear end of the second bevel gear. The left end of the lifting gear is meshed and connected. With rack.

The cutting device includes a high-speed motor fixedly installed in the cutting box. A high-speed shaft is connected to the right end of the high-speed motor. A high-speed shaft is fixed on the high-speed shaft. The lower wall of the cutting box is annular. The array is provided with ten infrared signal monitors, which can monitor the living body and send a start signal.

Advantageously, an oil storage tank is provided in the cutting box, and an upper pipe is connected to the lower end of the oil storage tank, and a hydraulic pump is connected to the lower end of the upper pipe, and the hydraulic pump can receive the start from the infrared signal monitor. Signal, the hydraulic pump is fixed in the hydraulic pump cavity, the lower end of the hydraulic pump is connected with a lower pipe, the lower end of the lower pipe is symmetrically connected with a piston, and the piston is fixed in the piston cavity. The piston is provided with a piston rod that can slide left and right. One end of the piston rod near the cutting blade is symmetrically fixed with a spring. The spring is fixed to the cutting box at one end near the cutting blade. The piston rod A connecting shaft is fixed on the right end, and a brake pad is fixed on one end of the connecting shaft near the cutting blade. When the brake pad approaches the end of the cutting blade, the cutting blade can be clamped so that the cutting The knife stopped turning.

The beneficial effects of the present invention are: the structure of the present invention is simple, the maintenance is convenient, and the use is convenient. The device can automatically adjust the cutting position, and at the same time, it can automatically monitor the living body during the metal cutting process. It can automatically start the built-in emergency clamping device to clamp the blade, so that the blade stops rotating, preventing the blade from cutting the human body and causing injury to the human body, thereby greatly improving the safety during production and preventing accidental injury.

### BRIEF DESCRIPTION OF THE DRAWINGS

For ease of explanation, the present invention is described in detail by the following specific embodiments and the accompanying drawings.

FIG. 1 is a schematic diagram of the overall structure of a metal cutting machine with an anti-cut hand according to the present invention; FIG.

FIG. 2 is an enlarged schematic view of the “A-A” structure of FIG. 1; FIG.

3 is an enlarged schematic view of the “B-B” structure of FIG. 1;

4 is an enlarged schematic view of the “C” structure of FIG. 1;

FIG. 5 is an enlarged schematic view of the “D” structure of FIG. 1.

### DETAILED DESCRIPTION OF THE INVENTION

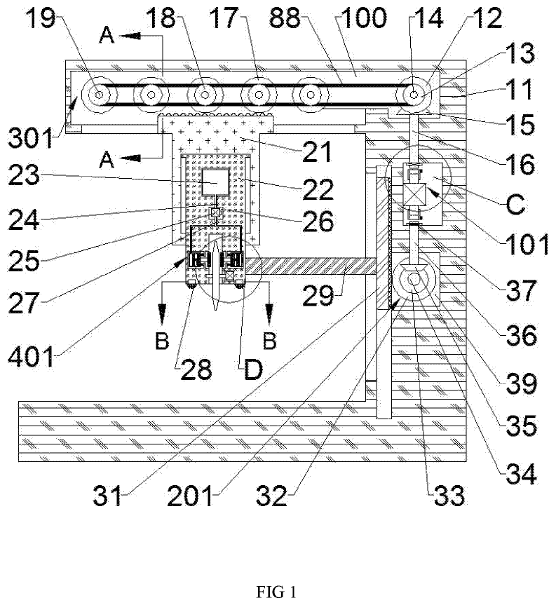

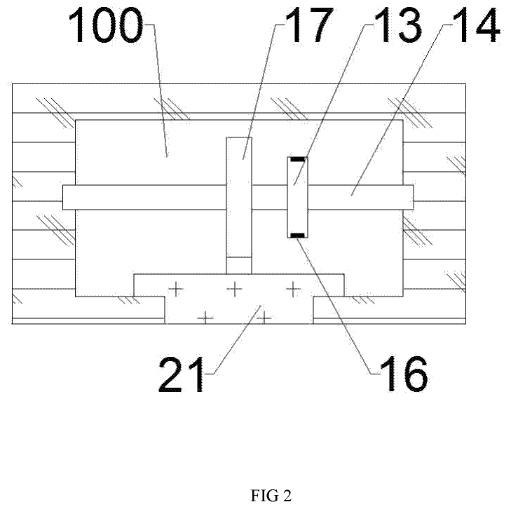

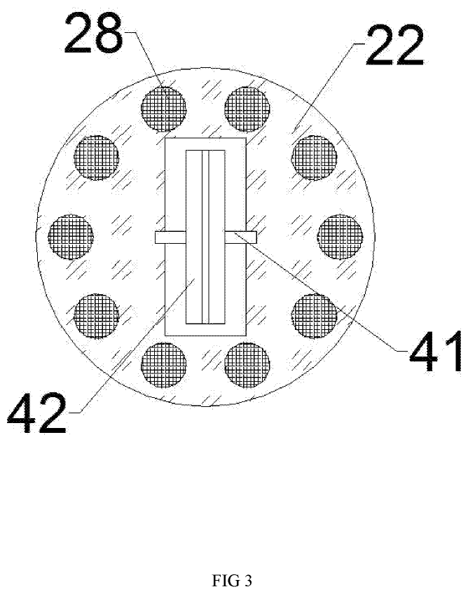

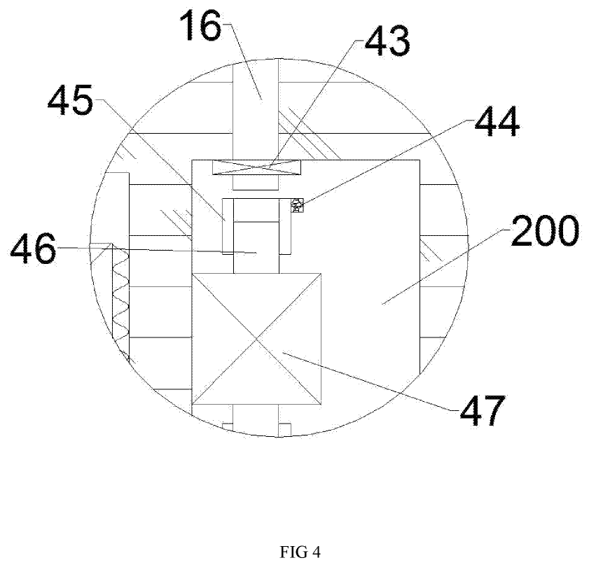

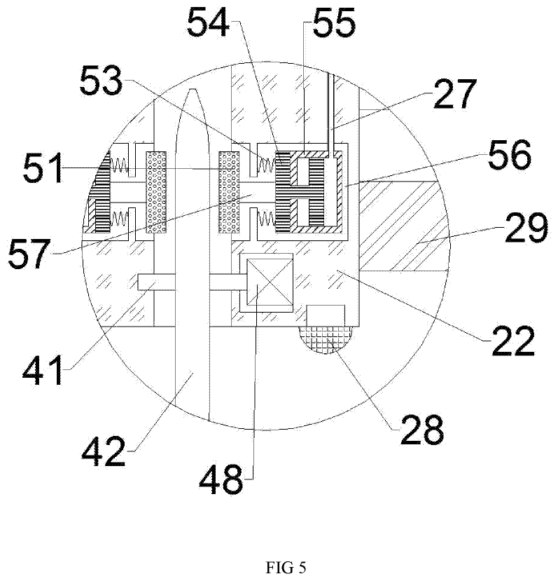

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1 itself.

The invention relates to a metal cutting machine with anti-cutting hands, which is mainly used for metal cutting. The invention will be further described below with reference to the drawings of the invention:

An anti-cut hand metal cutting machine according to the present invention includes a cutting base 11. A main power chamber 200 is provided in the cutting base 11, and a power device 101 is provided in the main power chamber 200. The power device 101 can provide power for the device. A pulley cavity 100 is provided in the upper wall of the main power cavity 200. A sliding device 301 is provided in the pulley cavity 100. A rotatable sliding gear 17 is provided in the sliding device 301. The lower end of the sliding gear 17 is provided with a sliding box 21 that can slide left and right, and a rack is fixed at the upper end of the sliding box 21, and the lower end of the sliding gear 17 can be meshed with the sliding box 21. 21 is provided with a cutting box 22 that can slide up and down. The cutting box 22 is provided with a cutting device 401. The cutting device 401 can cut metal materials. The sliding device 301 is provided with a rotatable lower transmission. Gear 15 is provided with a rotatable upper transmission shaft 16 in the power unit 101. The upper end of the upper transmission shaft 16 extends into the pulley cavity 100 and the upper end of the upper transmission shaft 16 is fixed to the lower transmission gear 15. Connected, and further the power unit 101 can pass through the upper The moving shaft 16 and the lower transmission gear 15 transmit power to the sliding device 301, and the sliding device 301 can drive the sliding box 21 to slide left and right. A gear cavity 39 is provided in the lower wall of the main power chamber 200. In the gear cavity 39, a cutter lifting device 201 is provided. The cutter lifting device 201 is provided with a rack 31 that can slide up and down. The left end of the rack 31 is fixed with a connecting rod 29. The left end of the connecting rod 29 is fixed. It is fixedly connected to the cutting box 22, and the cutter lifting device 201 can drive the cutting box 22 to slide up and down through the connecting rod 29. The cutter lifting device 201 is provided with a rotatable first bevel gear 35, The power device 101 is provided with a rotatable lower transmission shaft 36, and a lower end of the lower transmission shaft 36 is fixedly connected to the first bevel gear 35, and the power device 101 can transmit power to the cutter lifting device. 201.

According to an embodiment, the power device 101 is described in detail below. The power device 101 includes a main motor 47 fixed in the pulley cavity 100, and a first power shaft 46 is dynamically connected to the main motor 47. A hollow shaft 45 is symmetrically sleeved on the upper and lower ends of the first power shaft 46. The hollow shaft 45 is splined to the first power shaft 46. A magnetic block 44 is fixed to the right end of the hollow shaft 45. A first electromagnet 43 is fixed on the upper transmission shaft 16. When the first electromagnet 43 is energized, the magnetic block 44 at the upper end can be attracted, and the hollow shaft 45 at the upper end can be connected with the upper transmission shaft 16 is meshed and connected, and the hollow shaft 45 at the lower end can be meshed with the lower transmission shaft 36. A second electromagnet 37 is fixed on the lower transmission shaft 36. When the second electromagnet is fixed, When power is applied to 37, the magnetic block 44 at the lower end can be attracted.

According to an embodiment, the sliding device 301 is described in detail below. The sliding device 301 includes a driving shaft 14 rotatably disposed in the pulley cavity 100, and an upper transmission gear 12 is fixed on the driving shaft 14. The lower end of the upper transmission gear 12 is meshed with the lower transmission gear 15, the lower end of the lower transmission gear 15 is fixedly connected to the upper transmission shaft 16, and the driving shaft 14 is provided with a driving wheel 13. A wheel 13 is located at the front end of the upper transmission gear 12. A belt 88 is connected to the driving wheel 13, and five pulley shafts 19 are arrayed at the left end of the driving shaft 14. A belt pulley 18 is fixed on the pulley shaft 19. The belt pulley 18 is connected to the driving wheel 13 through the belt 88, and the sliding gear 17 is fixed on the pulley shaft 19.

According to an embodiment, the tool lifting device 201 is described in detail below. The tool lifting device 201 includes a positioning shaft 34 rotatable in the gear cavity 39, and a second shaft is fixed on the positioning shaft 34. Bevel gear 33, the upper end of the second bevel gear 33 is meshed with the first bevel gear 35, the upper end of the first bevel gear 35 is fixedly connected to the lower transmission shaft 36, and the positioning shaft 34 is fixedly provided A lifting gear 32 is located at the rear end of the second bevel gear 33. A left end of the lifting gear 32 is meshed with a rack 31.

According to an embodiment, the cutting device 401 will be described in detail below. The cutting device 401 includes a high-speed motor 48 fixed in the cutting box 22, and a high-speed shaft 41 is connected to the right end of the high-speed motor 48. A cutting blade 42 is fixed on the high-speed shaft 41, and ten infrared signal monitors 28 are arranged in a circular array in the lower wall of the cutting box 22. The infrared signal monitors 28 can monitor a living body and send a start signal.

Beneficially, an oil storage tank 23 is provided in the cutting box 22, and an upper pipe 24 is connected to a lower end of the oil storage box 23, and a hydraulic pump 25 is connected to a lower end of the upper pipe 24. Said start signal of the infrared signal monitor 28, the hydraulic pump 25 is fixed in the hydraulic pump cavity 26, the lower end of the hydraulic pump 25 is provided with a lower pipe 27, and the lower end of the lower pipe 27 is symmetrically connected with a piston. 55. The piston 55 is fixed in the piston cavity 56. The piston 55 is provided with a piston rod 54 that can slide left and right. A spring 53 is fixed symmetrically on one end of the piston rod 54 near the cutting blade 42. One end of the spring 53 near the cutting blade 42 is fixedly connected to the cutting box 22, a right end of the piston rod 54 is fixed with a connecting shaft 57, and one end of the connecting shaft 57 is fixed with a brake pad near the cutting blade 42. 51, and when the brake pad 51 approaches the one end of the cutting blade 42, the cutting blade 42 can be clamped so that the cutting blade 42 stops rotating.

The following is a detailed description of the use of an anti-cut hand metal cutting machine in this article in conjunction with FIGS. 1 to 5: In the initial state, the main motor 47, high-speed motor 48, and hydraulic pump 25 do not start, and the infrared signal monitor 28 Closed, the cutting box 22 is completely retracted into the sliding box 21, the first electromagnet 43 and the second electromagnet 37 are not energized, the hollow shaft 45 at the upper end does not mesh with the upper transmission shaft 16, and the hollow shaft 45 at the lower end does not contact the lower The transmission shaft 36 is engaged. When processing is started, the main motor 47 is started. The main motor 47 drives the first power shaft 46 to rotate, and the first power shaft 46 drives the hollow shaft 45 to rotate. At this time, the first electromagnet 43 is energized, so that the first The electromagnet 43 attracts the magnetic block 44, so that the magnetic block 44 drives the hollow shaft 45 to slide upward, thereby causing the hollow shaft 45 to mesh with the upper drive shaft 16, so that the first power shaft 46 drives the upper drive shaft 16 to rotate through the hollow shaft 45, and the upper drive The shaft 16 drives the driving shaft 14 to rotate through the lower driving gear 15 and the upper driving gear 12. The driving shaft 14 drives the pulley shaft 19 through the driving pulley 13, the belt 88 and the belt pulley 18. The pulley shaft 19 drives the sliding gear 17 to rotate, and the sliding gear 17 Enter Drive the slide box 21 to slide left and right, so that the cutting blade 42 is adjusted to the processing position. At this time, the first electromagnet 43 is powered off, the hollow shaft 45 is separated from the upper drive shaft 16, and the second electromagnet 37 is energized to make the second electromagnet. 37 attracts the magnetic block 44 at the lower end, so that the magnetic block 44 drives the lower hollow shaft 45 to slide downward, thereby causing the hollow shaft 45 to mesh with the lower transmission shaft 36, so that the first power shaft 46 drives the lower transmission shaft 36 to rotate through the hollow shaft 45 The lower transmission shaft 36 drives the positioning shaft 34 to rotate through the first bevel gear 35 and the second bevel gear 33. The positioning shaft 34 drives the rack 31 to slide up and down through the lifting gear 32, and the rack 31 drives the cutting box 22 up and down through the connecting rod 29. Slide to adjust the cutting blade 42 to the cutting height, then turn off the main motor 47 and start the high-speed motor 48. The high-speed motor 48 drives the cutting blade 42 to rotate at a high speed through the high-speed shaft 41, so that the cutting blade 42 starts cutting metal materials, and the infrared signal is monitored at the same time The monitor 28 enables the monitoring function. When the human body enters the area surrounded by the infrared signal monitor 28, the infrared signal monitor 28 can detect the human body's entry and start the liquid by sending a signal. The pump 25 and the hydraulic pump 25 pump the hydraulic oil in the oil storage tank 23 into the piston 55 through the upper pipe 24 and the lower pipe 27, and then push the piston rod 54 to slide toward the end near the cutting blade 42 so that the piston rod 54 is driven by the connecting shaft 57 The brake pad 51 clamps the cutting blade 42 so that the cutting blade 42 stops rotating instantly to avoid harm to the human body. When the human body leaves the monitoring area of the infrared signal monitor 28, the infrared signal monitor 28 sends a signal to shut down the hydraulic pump 25 and the piston rod. 54 is reset by the elastic force of the spring 53 so that the hydraulic oil flows back into the oil storage tank 23 and the brake pad 51 is reset at the same time, so that the cutting blade 42 continues to rotate and performs the cutting operation.

The beneficial effects of the present invention are: the structure of the present invention is simple, the maintenance is convenient, and the use is convenient. The device can automatically adjust the cutting position, and at the same time, it can automatically monitor the living body during the metal cutting process. It can automatically start the built-in emergency clamping device to clamp the blade, so that the blade stops rotating, preventing the blade from cutting the human body and causing injury to the human body, thereby greatly improving the safety during production and preventing accidental injury.

The above are only specific embodiments of the invention, but the scope of protection of the invention is not limited to this. Any changes or replacements that are not thought through without creative work should be covered by the scope of protection of the invention. Therefore, the protection scope of the invention shall be subject to the protection scope defined by the claims.

1. An anti-cut hand metal cutting machine according to the present invention includes a cutting base. A main power chamber is provided in the cutting base, and a power device is provided in the main power chamber. The power device can provide power to the device;
A pulley chamber is provided in the upper wall of the main power chamber, and a sliding device is provided in the pulley chamber. A rotatable sliding gear is provided in the sliding device, and a sliding box capable of sliding left and right is provided at the lower end of the sliding gear. A rack is fixed at the upper end of the sliding box, and the lower end of the sliding gear can be meshed with the sliding box. The sliding box is provided with a cutting box that can slide up and down. The cutting box is provided with a cutting device. The cutting device can perform cutting processing on metal materials;
The sliding device is provided with a rotatable lower transmission gear, and the power device is provided with a rotatable upper transmission shaft. The upper end of the upper transmission shaft extends into the pulley cavity and the upper end of the upper transmission shaft is connected to the upper transmission shaft. The lower transmission gear is fixedly connected, so that the power device can transmit power to the sliding device through the upper transmission shaft and the lower transmission gear, and the sliding device can drive the sliding box to slide left and right;
A gear cavity is provided in the lower wall of the main power cavity, and a cutter lifting device is provided in the gear cavity. The cutter lifting device is provided with a rack that can slide up and down, and a connecting rod is fixed at the left end of the rack. The left end of the connecting rod is fixedly connected to the cutting box, and the cutter lifting device can drive the cutting box to slide up and down through the connecting rod. The cutter lifting device is provided with a rotatable first bevel gear. The power device is provided with a rotatable lower transmission shaft, and the lower end of the lower transmission shaft is fixedly connected to the first bevel gear, so that the power device can transmit power to the cutter lifting device.

2. The anti-cut hand metal cutting machine according to claim 1, wherein the power device comprises a main motor fixedly installed in the pulley cavity, and a first power is connected to the main motor. A hollow shaft is symmetrically sleeved on the upper and lower ends of the first power shaft, the hollow shaft and the first power shaft are connected by a spline, a magnetic block is fixed at the right end of the hollow shaft, and the upper transmission A first electromagnet is fixed on the shaft. When the first electromagnet is energized, the magnetic block located at the upper end can be attracted. The hollow shaft located at the upper end can be meshed with the upper transmission shaft. The hollow shaft can be meshed with the lower transmission shaft, and a second electromagnet is fixed on the lower transmission shaft. When the second electromagnet is energized, the magnetic block at the lower end can be attracted.

3. The anti-cut hand metal cutting machine according to claim 2, wherein the sliding device comprises a driving shaft rotatably provided in the pulley cavity, and an upper transmission is fixed on the driving shaft. A gear, the lower end of the upper transmission gear is meshed with the lower transmission gear, the lower end of the lower transmission gear is fixedly connected to the upper transmission shaft, and a driving wheel is provided on the driving shaft, and the driving wheel is located on the uploader A front end of a moving gear, a belt is connected to the driving wheel, and five pulley shafts are arranged in an array at the left end of the driving shaft; a belt pulley is fixed on the pulley shaft, and the belt pulley and the driving wheel pass through the belt is connected, and the sliding gear is fixed on the pulley shaft.

4. The anti-cut hand metal cutting machine according to claim 2, wherein the cutter lifting device comprises a positioning shaft rotatable in the gear cavity, and the positioning shaft is fixedly provided with a first A two-bevel gear, the upper end of the second bevel gear is meshed with the first bevel gear, the upper end of the first bevel gear is fixedly connected to the lower transmission shaft, and a lifting gear is fixed on the positioning shaft, The lifting gear is located at the rear end of the second bevel gear, and the left end of the lifting gear meshes with a rack.

5. The anti-cut hand metal cutting machine according to claim 1, wherein the cutting device comprises a high-speed motor fixedly installed in the cutting box, and a high-speed shaft is connected to the right end of the high-speed motor. A cutting knife is fixed on the high-speed shaft, and ten infrared signal monitors are arranged in a circular array in the lower wall of the cutting box, and the infrared signal monitor can monitor a living body and send a start signal.

6. The anti-cut hand metal cutting machine according to claim 5, characterized in that: the cutting box is provided with an oil storage tank, an upper pipe is connected to the lower end of the oil storage tank, and a lower pipe is connected to the lower end of the upper pipe. A hydraulic pump that can receive a start signal from the infrared signal monitor. The hydraulic pump is fixed in the hydraulic pump cavity. A lower pipe is connected to the lower end of the hydraulic pump, and the lower end of the lower pipe is symmetrical to the left and right. A piston is connected to the piston, the piston is fixed in the piston cavity, and a piston rod that can slide left and right is arranged in the piston. A spring is fixed symmetrically on one end of the piston rod near the cutting blade. An end near the cutting blade is fixedly connected to the cutting box, a connecting shaft is fixed at the right end of the piston rod, and a brake pad is fixed near the cutting blade at one end, and when the brake pad faces the When one end of the cutting blade approaches, the cutting blade can be clamped so that the cutting blade stops rotating.
